(19) United States
(12) Patent Application Publication
(10) Pub. No.: US 2002/0143687 A1
(43) Pub. Date: Oct. 3, 2002

(54) Method and system for auctioning bad debts utilizing an assorting arangement based on the geographic locaiton where jurisdiction is present over the debtor

(76) Inventor: Reuben Bahar, West Hills, CA (US)

Correspondence Address: REUBEN BAHAR, 23708 WELBY WAY, WEST HILLS, CA, 91307, US

(21) Appl. No.: 09/822,732

(22) Filed: Mar. 30, 2001

(51) Int. Cl. G06F 17/60

(52) U.S. Cl. 705/37

(57) ABSTRACT

A method and system for auctioning bad debts utilizing an assorting arrangement based on the geographic location where jurisdiction is present over the debtor. Clients in the public may remotely access and participate in an online auction forum for the purpose of buying bad debts. Bad debts may be classified into a designated location bidding site database that relates to a particular geographic location. A designated location bidding site that that is related to the same geographic location as that of the database may rotatively display bad debts for buyers wishing to view or bid on them. In this manner, creditors may sell bad debts they own by being able to easily and more effectively, locate buyers who are situated in or near a territorial location that has jurisdiction over the debtor.

### BACKGROUND OF THE INVENTION

The field of the invention is online auctions and the invention relates more particularly to a method and system for auctioning bad debts.

Online auctions have regularly been used to sell products to the bidder who posts the highest bid. In recent years, this method of selling has gained much popularity among growing businesses and product merchants. The reasons for this relates to the selling advantages that can only be offered by online auctions. For example, online auctions allow the seller to obtain a far greater customer reach then is offered by other selling methods. In this respect, much more consumers can participate in the sale of a good since they can join the auction at any place and time simply by logging onto the appropriate internet site. Additionally, online auctions allow sellers to categorize a multitude of distinct items so that bidders may quickly be able to find and bid on any particular item they want.

Although most products and items can be sold through an online auction, bad debts are of significant interest. Since the emergence of credit based transactions, creditors and lending institutions have continuously been burdened by a debtor's failure to pay their debt. Although several collection schemes such as payment plans and debt reduction are routinely used by lending institutions and collection agencies, the amount of uncollected and/or delinquent bad debt (herein after “bad debt”) remains staggering. Often, the only viable method for collection of the bad debt is legal action.

Despite the advantages offered by legal recourse, it has severe limitations. Most prominent of these involve jurisdictional issues. This is because a debtor can only be sued in a court of law that has jurisdiction over him (i.e. jurisdiction over the debtor's person or property). Often, this means that the debtor must be sued in the state where they reside or are most likely, domiciled. As a result, creditors who are situated in other jurisdictions are placed at a severe disadvantage. In order to collect the debt, they must either travel to the state holding jurisdiction or hand the debt over to a collection agency. The first option would cause the creditor to incur expenses in lost time, work, and travel while the second would require them to pay high fees for collection efforts and await resolution.

It should be mentioned that in some situations, a state court can have jurisdiction over a debtor that no longer lives within its state's boundaries. This usually occurs if the debtor has had sufficient contact with, or has tangible assets situated in that particular state. The result is that a creditor can get a judgment against a debtor in one of these states. Although this would appear to make it easier for the creditor to collect, especially if the creditor is situated in that particular state, such is rarely the case. This is because most debtors with delinquent and/or uncollected debts do not leave any assets in states they no longer live in. Furthermore, given the debtor's non-domicile in the state, a garnishment order from that state's court is not a practical method for collecting the bad debt due to issues relating to enforcement. In the event that such an order is obtained, the creditor would most likely need to go to a court that is situated in the debtor's current state of domicile and obtain an order enforcing the prior state's judgment. Such efforts clearly involve a substantial degree of hassle and expense. Therefore, it is no surprise that a judgment in a state where the debtor is not domiciled does little or nothing towards collection of the bad debt. The reality is that in most situations, collecting a bad debt from its debtor is only possible in jurisdictions where the debtor is situated or domiciled. This is simply because it is there where the debtor and most of their assets are likely to be located.

As if collection of bad debts was not hard enough, efforts have been further curtailed by a debtor's frequent and sudden leave from a given jurisdiction. It is a reality that people regularly re-locate from state to state for various reasons. This behavior, however, tends to occur more frequently with debtors who attempt to avoid payment of a financial judgment against them. All too often, the result is that a creditor, after having spent time and money in obtaining a judgment in a particular jurisdiction, will have to chase the debtor into a new jurisdiction in order to collect the debt. This scenario can repeat over and over resulting in endless amounts of time and money spent with no substantial recovery of the debt at issue.

Due to these problems, selling the bad debt has, in many respects, become the preferred method for disposing of it. This is because selling the bad debt to a 3^{rd} party ensures some payment to the creditor unlike collection efforts which may be unsuccessful. Although selling the bad debt would require the creditor to discount its value, the risk of collection would nevertheless, be passed on to the 3^{rd} party buyer. Here, the creditor would quickly liquefy the debt and avoid the burdens of chasing the debtor for a judgment and final payment. It is noteworthy to mention that selling the bad debt as opposed to holding it and attempting to collect has one other appealing factor. With efforts to collect, even assuming that satisfactory payment is made, the creditor looses valuable interest and business opportunity that could have been generated from a quick sale of the bad debt.

Although the idea of selling bad debts to third parties is promising, such a scheme is difficult to achieve on a high volume scale given the problem of finding buyers situated in the debtor's jurisdictional district. This problem is especially troublesome to firms issuing credit whose customers are nationally spread. Since most potential bad debt buyers would find it unprofitable to purchase bad debts belonging to debtors that were out of their jurisdiction's reach, efforts to sell have been limited.

Several companies have developed online auctions aimed at selling debt. Unfortunately, these sites focus on the sale of debts in good standing (i.e. non-delinquent debts such as mortgage loans) rather then uncollected and/or delinquent debts. Furthermore, none of these sites deal with the jurisdictional problem associated with collection of bad debts.

### BRIEF SUMMARY OF THE INVENTION

The present invention is for a method and system for auctioning bad debts utilizing an assorting arrangement based on the geographic location where jurisdiction is present over the debtor. The method and system establishes an online auction forum on a remote host system which is connected to a communications network and utilizes hardware and software means. The online auction software may be configured to run multiple, concurrent, and distinct auction sessions on the remote host system, and has database modules and at least one designated location bidding site. Each database module relates to a specific geographic location and contains data for bad debts that are associated with the same geographic location as that of the database module. Additionally, each database module relates to a designated location bidding site that is associated with the same geographic location as that of the database module. The data for each bad debt can consist of select information pertaining to the bad debt that is determined to be informative and suitable for display on the auction forum and comprises a distinct bad debt item. Bad debt items contained in a particular database module can be rotatively displayed on the designated location bidding site that relates to the same geographic location as that of the database module. Potential buyers wishing to view or bid on bad debt items may enter the desired designated location bidding site for such purposes. Bad debt items that do not generate the minimum bid request amount may be classified back into their respective database so that they may be re-displayed on the location bidding site at a later time. In the alternative, bad debt items that do generate the minimum bid request amount will be deemed sold and may be re-classified into a database designated for processing. Through this method and system, it is expected that creditors may collect on bad debts owed to them by being able to easily and more effectively, locate buyers who are situated in a territorial district that has jurisdiction over the debtor.

### BRIEF DESCRIPTION OF THE DRAWINGS

FIG. 1 is an overview flowchart depicting the general flow of information that occurs between a remote host system and multiple client systems in the method and system for auctioning bad debts in accordance with an embodiment of the present invention.

FIG. 2 is a screen view of a location bidding site selection menu, as seen from a client system, in accordance with an embodiment of the present invention.

FIG. 3 is a screen view of a designated location bidding site, as seen from a client system, in accordance with an embodiment of the present invention, wherein an auction for three bad debt items is currently running.

FIG. 4 is a screen view of three distinct types of bad debt items, each of which can be seen from a client system.

FIG. 5 is an overview flowchart pictorially depicting the continuous rotation of bad debt items from their respective designated location bidding site database to their respective designated location bidding site and back again.

FIG. 6 is a block diagram of the information flow that occurs in the method and system for auctioning bad debts in accordance with a preferred embodiment of the present invention.

### DETAILED DESCRIPTION OF THE PREFERRED EMBODIMENTS

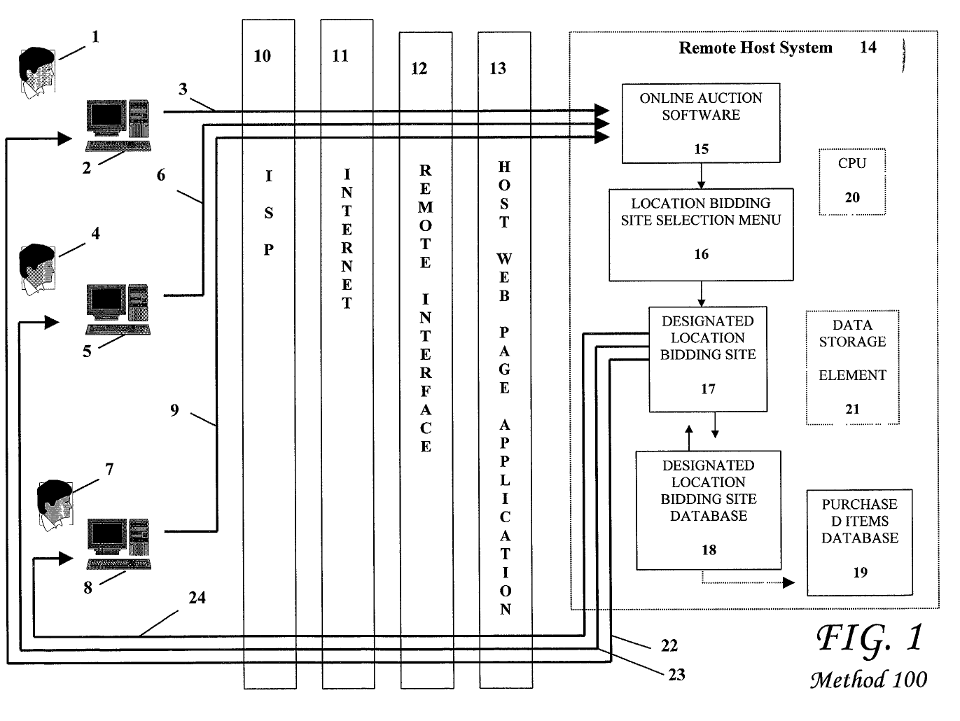

FIGS. 1-6 together show a method and system (hereinafter “method”), generally indicated at reference character 100 in FIG. 1, for auctioning, over a communications network, such as the Internet, bad debts utilizing an assorting arrangement based on the geographic location where jurisdiction is present over a debtor. All the FIGS. illustrate a process by which a client can locate, bid for, and purchase bad debts that may be collected in a territorial district that has jurisdiction over the debtor and in which the purchaser and debtor are most likely situated.

As noted in the background discussion, the geographic location where jurisdiction is present over the debtor is a key factor in selling a bad debt to a third party purchaser. To this effect, the method 100 functions to drastically increase the potential buyers for bad debts by making the bad debts readily available to clients located in or near the geographic location(s) that have jurisdiction over the debtor. This may be accomplished by classifying a bad debt in a location bidding site database that is associated with a territory location which has jurisdiction over the respective debtor. As a result, creditors will be able to sell their bad debts much more quickly, efficiently, and without the expense and burdens typically associated with collection efforts. Thus, the method 100 provides an online environment from which potential clients can bid for a bad debt and, if successful in purchasing it, undertake collection efforts themselves.

It is notable that the term “bad debt” is defined and understood herein and in the claims to mean any owed debt that is uncollected and/or delinquent. Bad debts are typically possessed by most creditors including, but not limited to, banks, lenders, credit institutions, retailers, wholesalers, private parties, etc. Bad debts may also be held by collection agencies who's job it is to liquefy the debt owned by themselves or by a 3^{rd} party creditor. The term “bad debt item” is defined and understood herein and in the claims to mean a collection of data comprised of select information pertaining to a particular bad debt. Select information can consist of data that is determined to be informative and suitable for display on the online auction forum. Such data can be, but is not limited to the geographic location where the debtor is currently situated, the geographic location of all the known territories that have jurisdiction over the debtor, the uncollected value of the bad debt, the debtor's identity profile, a predetermined minimum bid request amount, the fractional share and value that was apportioned from the whole of a bad debt, etc. Additionally, select information can include rating information that is related to the potential for collection of the bad debt (e.g. the debtor's credit rating as per Dunn & Brad Street/TRW standards, etc.) and an estimation as to the chances for collection. Lastly, it should be mentioned that the collection of data, comprising the bad debt item, can pertain, but is not limited to, one bad debt in its entirety, an assortment of distinct bad debts grouped together (hereinafter “lot package”), or a financially broken-up portion/fraction of a whole bad debt (hereinafter “apportioned bad debt”), and will be further discussed later in this disclosure.

It is also notable that although the following discussion will primarily be in the context of the Internet (11 in FIG. 1), also known as the World Wide Web, the term “communications network”, as used herein and in the claims, is intended to include all forms of network environments that are known to those in the relevant technical art. Thus, the method 100 is equally applicable to all interconnected computer systems capable of transmitting and receiving data, including, but not limited to, all telecommunications networks such as the Internet 11 (i.e. the World Wide Web), gopher, and BBS systems, etc. Furthermore, method 100 is applicable to all data communication systems, including, but not limited to, hardwire telephony, wireless networks such as cellular and PCS systems, satellite networks, etc.

FIG. 1 shows the general flow of information that occurs between a remote host system and multiple client systems in the method 100. The method 100 enables a host service provider operating a remote host system, generally indicated at reference character 14, to provide an online auction software 15 to clients in the general public, represented by three individuals indicated at reference characters 1, 4, and 7. The software 15 is typically installed on data storage element 21, such as a hard drive disk or other data storage medium, and is processed and executed by data processing element, such as a central processing unit (CPU) 20 that is working with a system memory element (not shown). Furthermore, the software 15 can be network configured to run multiple, concurrent, and distinct auction sessions on the remote host system 14, in a manner known to those in the relevant art. Thus, multiple clients may concurrently and individually access and participate in distinct auctions, each of which is running on online auction software 15, as indicated by arrows 3,6, and 9. Finally, remote interface element 12 may allow for public access to the online auction software 15 so that each of the clients 1, 4, and 7, can participate in a particular auction that is running on online auction software 15.

Accessing the software 15 typically entail a process whereby the client logs on to the internet 11 through an internet service provider (ISP) 10. Upon entering the correct URL address, the client system(s) 2, 5, and/or 8 may be taken through remote interface,12 and preferably to the host web page application 13 prior to gaining access to online auction software 15. A host web page application, as referenced by character 13, would typically introduce the online auction software 15 and its operation to the client and would provide an initializing link to the software 15.

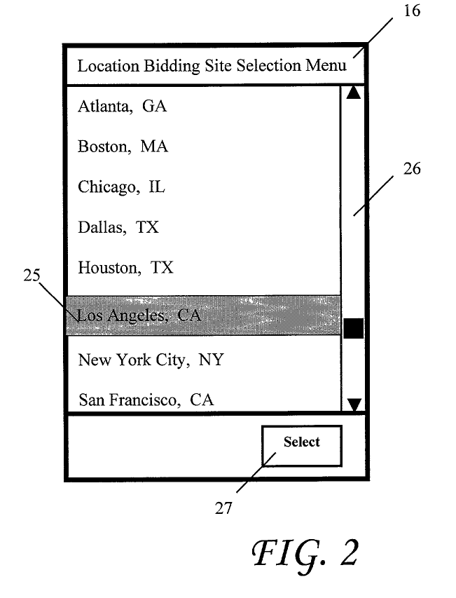

The online auction software 15 preferably has a location bidding site selection menu 16 which contains at least one geographic locality from which the client can choose. FIG. 2 illustrates location bidding site selection menu 16, as it may be seen from a client's system. The selection menu 16 has a variety of different geographic localities to choose from, a scroll bar 26, and a select button 27. Selection menu 16 allows each of the clients 1, 4, and 7 to choose a particular geographic locality from which to view and/or bid on bad debts. Each particular geographic locality on selection menu 16 is linked to a designated location bidding site that relates to the same geographic locality. For example, selection menu 16 displays that a client has highlighted the “Los Angeles, Calif.” locality, as shown by reference character 25. Upon clicking the select button 27, the client will be taken to the “Los Angeles bidding site”, which only displays bad debt items belonging to debtors who are under the jurisdiction of Los Angeles County. Of course, it is possible for a debtor to be under the jurisdiction of more then one territory. This is often the case when a debtor re-locates throughout the nation. Given this, the bad debt item can be displayed in a number of different designated location bidding sites, each of which relate to a territory that has jurisdiction over the debtor. Preferably, however, the geographic locality where the bad debt item is classified into is the territory that the debtor is currently domiciled in. This is because it is the debtor's current domicile where most of their assets are likely to be. Furthermore, it is in this territory where collection efforts including wage garnishment, asset attachment, liens, and the like are most likely to be successful. It should be mentioned that although selection menu 16 only displays eight geographic localities, it is, of course, contemplated that numerous other localities, each relating to a particular jurisdictional territory, may be utilized by the online auction software 15. Scroll bar 26, which is located on selection menu 16, illustrates this contemplation.

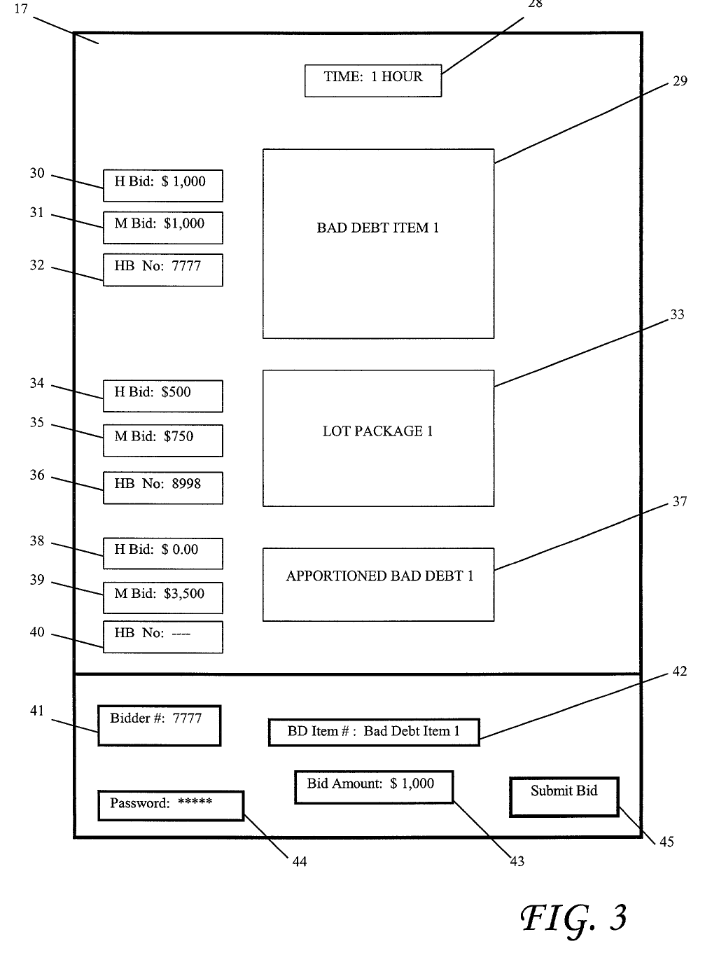

As shown in FIG. 3, after a particular locality is selected from selection menu 16, client system 2, 5, and/or 8 are taken to the designated location bidding site 17 that is related to the same geographic locality selected in selection menu 16. It is in the designated location bidding site 17 where bad debt items will preferably be auctioned and available for viewing by prospective clients. In this respect, data information may be transmitted from the designated location bidding site 17 to the client systems 2, 5, and 8, as indicated by reference characters 22, 23, and 24 respectively. As previously mentioned, the designated location bidding site 17 will preferably display bad debt items that belong to debtors who are under the jurisdiction of the same locality as that of the selected designated location bidding site.

As seen from client systems 2, 5, and/or 8, designated location bidding site 17 will display bad debt items currently being auctioned. The auctioning of bad debt items will preferably be conducted utilizing consecutive and concurrent bidding phase intervals. The term “bidding phase interval” is defined and understood herein and in the claims to mean a particular and separate auction session that has a predetermined running time, during which clients may bid on the specific bad debt items displayed for auction on that particular “bidding phase interval” auction session.

By stating that bidding phase intervals may run in a consecutive manner, it is meant that a new bidding phase interval will begin upon the ending of a prior bidding phase interval. To this effect, it is preferred that all of the bad debt items contained in a designated location bidding site database would not be displayed and auctioned at the same time. Here, the number of bad debt items displayed in a particular bidding phase interval can be predetermined. For example, the online auction software 15 can be programmed to allow only 15 bad debt items to appear in each bidding phase interval. After the end of that bidding phase interval, a subsequent bidding phase interval will appear, likewise, offering only 15 bad debt items.

The advantages to limiting the number of bad debt items auctioned per bidding phase interval are threefold. First, it allows clients to consider purchasing less favored or higher risk bad debt items. Second, displaying bad debt items on different bidding phase intervals entices a client to return to the online auction forum and view a new assortment of bad debt items, many of which would be placed on display for the first time. Last, a limitation arrangement would reduce confusion and delay in the bidding process by narrowing the amount of bad debt items that a client can choose to bid on. If the client is not content on bidding on any of the bad debt items displayed, they can simply wait until the next bidding phase interval (which contains a new assortment of bad debt items) begins.

By stating that bidding phase intervals may run in a concurrent manner, it is meant that each designated location bidding site, as exemplified by reference character 17, will display a separate and distinct bidding phase interval that runs simultaneously with other bidding phase intervals running on other designated location bidding sites. Additionally, it is contemplated that a designated location bidding site may have more then one bidding phase interval that is running “concurrently” with another bidding phase interval on the same designated location bidding site. In such a case, client(s) 1, 4, and/or 7, after entering a designated location bidding site, would be able to select from a number of distinct bidding phase intervals and view or bid on bad debt items that are up for auction in the particular bidding phase interval they chose. Preferably, however, each designated location bidding site would have single bidding phase intervals that are consecutively running one after the other.

Each bidding phase interval running on a designated location bidding site may indicate the amount of time that is left for bidding on bad debt items auctioned during that particular bidding phase interval. As seen in FIG. 3, designated location bidding site 17 has a time display 28, indicating that only one hour remains in the bidding phase interval. This means that there is only one hour left for clients to bid on the bad debt items displayed in the auction shown in FIG. 3. After the time limit expires for a bidding phase interval, that auction is officially closed and any further bids for bad debt items that were displayed are not allowed. At this point, any bad debt item that meets its predetermined minimum bid request amount may be deemed to be sold and re-classified into purchased items database 19. Bad debt items which did not meet their predetermined minimum bid request amount may be re-classified into their respective designated location bidding site database so that they may be auctioned off at a later time.

It is noteworthy to mention that the bidding time frame available for each bidding phase interval may be predetermined. Furthermore, it is contemplated that the bidding time frame may endure for the “long” or “short” term. For example, a long bidding time frame may allow the particular bidding phase interval to run for a duration of a week all the way up to a month, a year, or even beyond. Alternatively, a short bidding time frame may endure from five minutes all the way up to one hour, a few hours, a day, or even a few days. Preferably, however, each bidding phase interval will have a short bidding time frame that keeps the auction open for a short time duration. The advantage to having short bidding time frames is that a higher volume of bad debt items would be made available to potential buyers. This is because shorter time frames would translate into a greater amount of bidding phase intervals, many of which would contain a new assortment of bad debt items. The end result is that clients would be further enticed to visit the online auction forum and view or bid on the new assortment of bad debt items being auctioned.

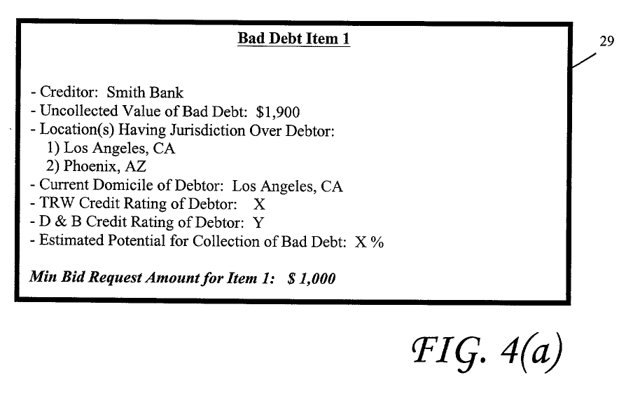

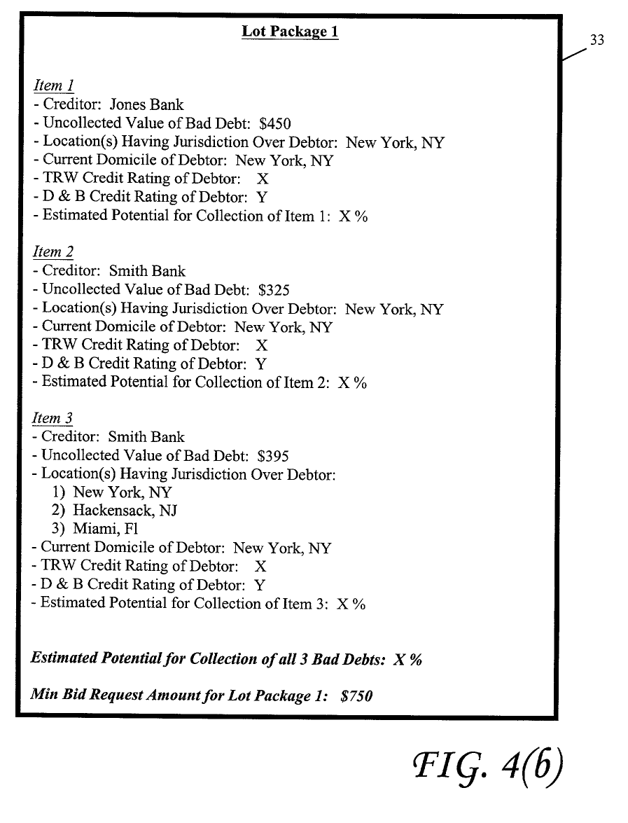

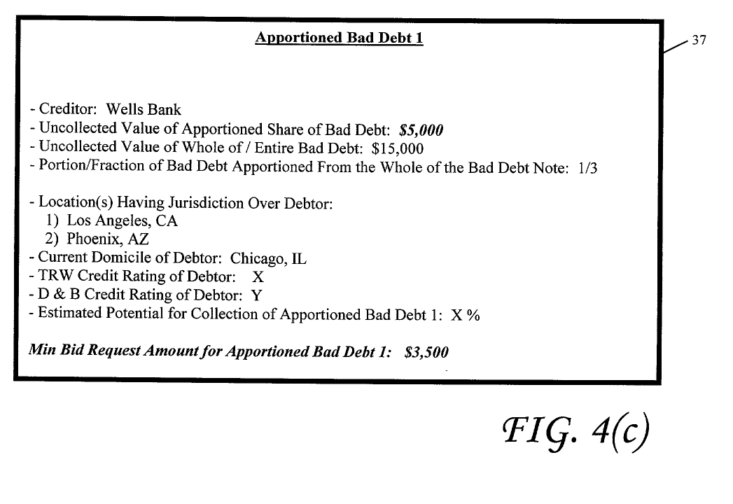

Returning to FIG. 3, client(s) 1, 4, and 7 are able to view bad debt item 1, indicated by reference character 29, lot package 1, indicated by reference character 33, and apportioned bad debt 1, noted by reference character 37. These bad debt items reference the three distinct types of bad debt items previously mentioned in this invention. FIG. 4 illustrates each of these types of bad debt items including various data that each could contain. The term bad debt item is defined and understood herein and in the claims to be a generic term referring to any collection of data comprised of select information derived from one or more bad debt(s). This includes data relating to one (whole) bad debt in its entirety, an assortment of distinct bad debts grouped together (i.e. “lot package”), and a financially broken-up portion/fraction of a whole bad debt (i.e. “apportioned bad debt”). A bad debt item referencing one (whole) bad debt will disclose data pertaining to only one bad debt. A bad debt item referencing a “lot package” will disclose data pertaining to two or more distinct bad debts that are grouped together in a common package. Although the bad debts assorted in a particular “lot package” can pertain to the same debtor, preferably, the “lot package” will include debts pertaining to an assortment of distinct debtors. Furthermore, it is preferred that all the bad debt items in a lot package would arise from debtors who are under the jurisdiction of at least one common territory.

Auctioning an assortment of bad debts in one lot package is advantageous when dealing with a multitude of bad debts, each of which has a low uncollected monetary value. This method generates a greater incentive for a buyer to purchase the bad debts then would have been the case had they been auctioned off individually. For example, most 3^{rd} party purchasers would find that the efforts needed to collect a $250 bad debt is not worth their while, and thus, not bid for it. However, when 5 of these $250 bad debts are sold together in one “lot package”, the incentive to purchase them increases tremendously. One other advantage in grouping bad debts together is that the buyer is able to diminish their risk of investment. In the event that one of the bad debts in the “lot package” becomes uncollectable, the buyer still has a chance to collect on the other bad debts included in the “lot package”.

Finally, a bad debt item referencing an “apportioned bad debt” will disclose data pertaining to a financially broken-up portion/fraction of one (whole) bad debt. Auctioning a financial portion/fraction of a bad debt is advantageous when the monetary value of the whole debt is large. This is because many buyers may hesitate to invest a large sum of money for a bad debt note that has already proven to be delinquent. The higher the value of the bad debt, the greater the chances that the note will not be collected from its debtor. By splitting up the debt into 2 or more financial portions/fractions, however, its sale becomes much easier and less risky. Here, each of the split portions could be auctioned off as a distinct bad debt item, thereby diminishing both investment and risk for the buyer. The result being that each buyer of an “apportioned bad debt” would become a creditor of the debtor for the full monetary value of the apportioned share of the bad debt. Although it is preferred that each “apportioned bad debt” be auctioned as a sole bad debt item, it is contemplated that 2 or more “apportioned bad debts” may be grouped together and auctioned as a “lot package”.

As shown in FIG. 3, each of the three mentioned types of bad debt items may have three block terminals next to it indicating the high bid amount, minimum bid request amount, and high bidder identification number/mark. For example, bad debt item 1, referenced by character 29, shows a high bid amount of $1,000, indicated by reference character 30, a minimum bid request amount of $1,000, indicated by reference character 31, and a high bidder identification number/mark 7777, indicated by reference character 32. This means that the bidder recognized by the numerals 7777, 32, bid $1,000, as per the minimum bid request amount for bad debt item 1, 31, and was in fact the high bidder for it, 30. If, by the end of the one hour bidding time limit 29, no other client submits a higher bid for bad debt item 1, 29, bidder 7777's, 32, offer of $1,000 will be accepted.

In a similar fashion, lot package 1, 33, is shown to have attracted a high bid of $500, 34, from high bidder 8998, 36. Unlike bad debt item 1, 29, however, the posted high bid for lot package 1, 33, has not met the predetermined minimum bid request amount. Unless the high bid for lot package 1, 33, is equal to or greater then $750, 35, at the end of the bidding time period 28, this bad debt item will not be sold. Finally, apportioned bad debt 1, 37, which has not yet attracted a bidder 40, shows a high bid of $0.00, 38, and a minimum bid request amount of $3,500, 39. If the indicated one hour time limit 28, expires before the minimum bid request amount is met, apportioned bad debt 1, 37, will be unsold and preferably classified into the designated location bidding site database from which it emerged.

As further shown in FIG. 3, designated location bidding site 17 may contain various block data input terminals that require the client to enter information when submitting a bid for a bad debt item. As illustrated, a client wishing to submit a bid, inputted their bidder identification number/mark 7777, as indicated by reference character 41. Bidder 7777 then indicated the bad debt item (bad debt item 1) which they desired to bid on, as noted by reference character 42. Third, a bid amount of $1,000 was entered, 43. As shown by reference character 44, the client preferably enters their personal password along with their bid. Requiring the client to enter their password will promote reliability in the bidding process by ensuring the legitimacy and authenticity of the bid. Finally, bidder 7777 clicked on the “submit” button 45, in order to submit their bid to the online auction forum. Since this bid was acceptable and was the high bid for bad debt item 1, 30, it was posted on the designated location bidding site 17. There, it may be seen by all other clients who entered that same designated location bidding site.

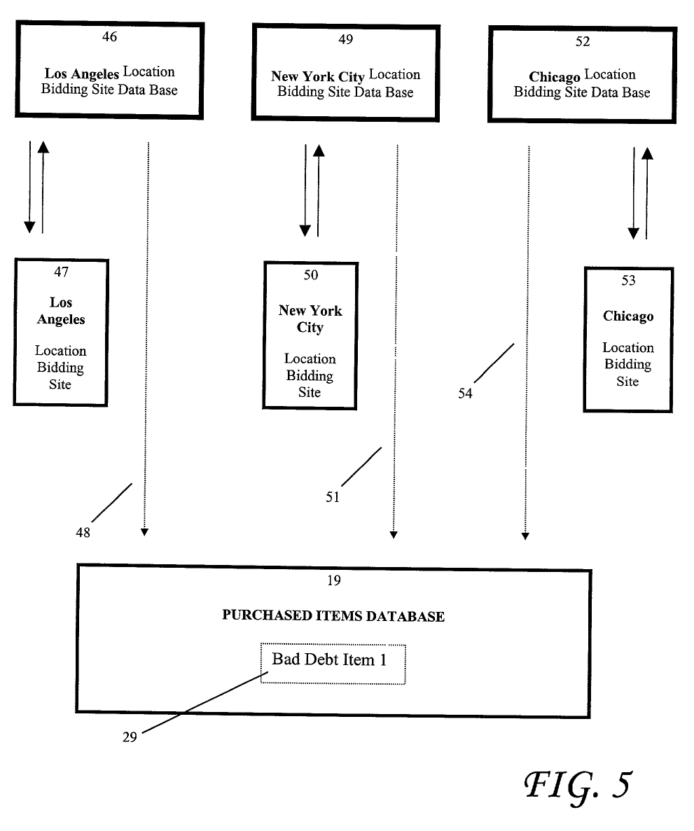

The process for auctioning bad debt items preferably requires designated location bidding site 17 to function in conjunction with designated location bidding site database 18, both of which are related to a common geographic territory. Bad debt items stored in a particular designated location bidding site database are preferably rotated from this module to their associated designated location bidding site, and back. This process may repeat until the bad debt items in the particular designated location bidding site database are sold, at which time they may be re-classified into purchased items database 19 for processing. As illustrated in FIG. 5, the “Los Angeles” location bidding site database 46 communicates with the “Los Angeles” location bidding site 47. Bad debt items contained in database 46 are placed on display in bidding site 47 during a given bidding phase interval. If after the conclusion of the bidding phase interval, a bad debt item is sold, it may be re-classified into purchased items database 19, as shown by reference character 48. There, the “sold” bad debt item will be stored for processing and submission to the buyer. Bad debt items displayed on bidding site 47 that are not sold during the bidding phase interval, may be removed from that location and placed back into database 46, whereupon a new group of bad debt items could be taken out of database 46 and displayed on bidding site 47.

Similarly, bad debt items located in the “New York City” location bidding site database 49 may be displayed on the “New York City” location bidding site 50. Those that are sold at the end of the bidding phase interval may be re-classified into purchased items database 19, as shown by reference character 51. Bad debt items that are not sold during the bidding phase interval may be removed from bidding site 50 and placed back into database 49, whereupon a new group of bad debt items could be taken out of database 49 and displayed on bidding site 50. Finally, the same scenario repeats with bad debt items contained in the “Chicago” location bidding site database 52 and the “Chicago” location bidding site 53. Reference character 54 indicates the re-classification of bad debt items that were sold from the “Chicago” bidding site 53, into purchased items database 19.

Bad debt items displayed in a given bidding phase interval can be selected from their designated location bidding site database by numeric, random, or manual selection. With numeric selection, software 15 may select the bad debt items for a bidding phase interval based on the numeric positioning of each bad debt item in its given database. Thus, if there are 100 bad debt items in the “Los Angeles” location bidding site database 46, 15 of which are to be selected per bidding phase interval, the first 15 may be chosen, followed by the next 15, and so on. With random selection, software 15 will select the bad debt items from their respective database without regard to their numerical positioning in the database. For example, assuming that only 15 bad debt items are to be chosen from the “Los Angeles” location bidding site database 46, bad debt items numerically positioned 16^{th}, 35^{th}, and 80^{th} can be posted in the same bidding phase interval. Finally, bad debt items appearing on a bidding phase interval can be selected on the basis of an order preference of the controlling personnel of the online auction forum. This will allow for specifically chosen bad debt items to be displayed in a selected bidding phase interval, as per a preferred organizational arrangement.

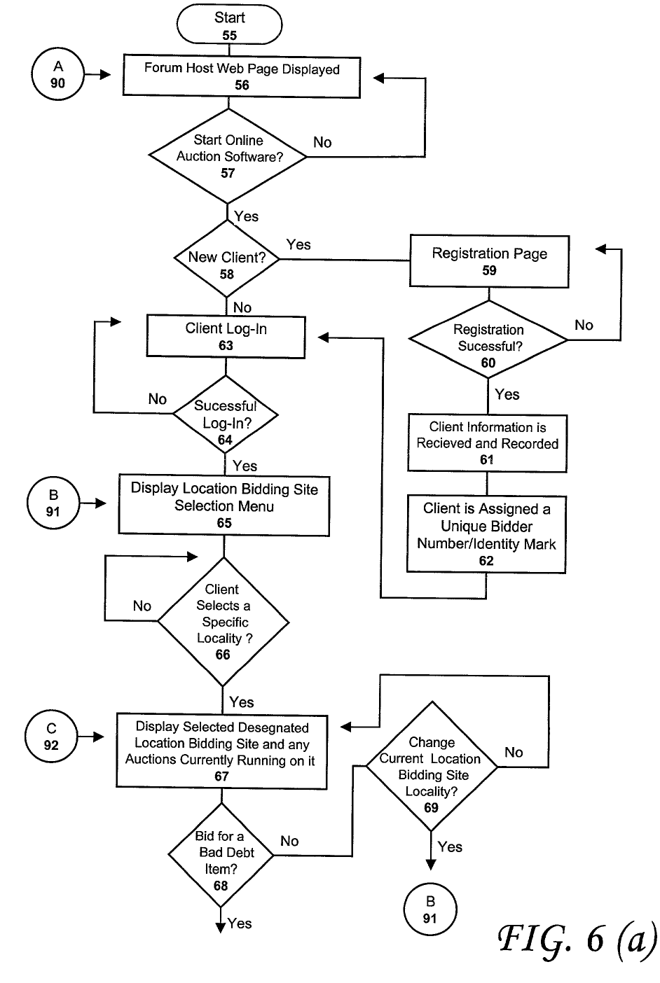

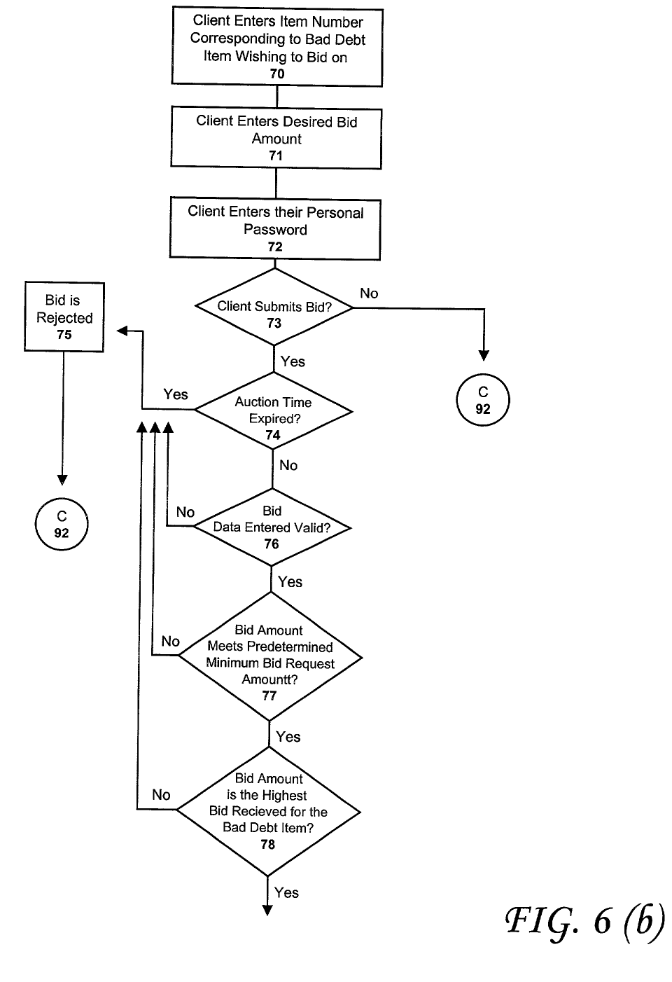

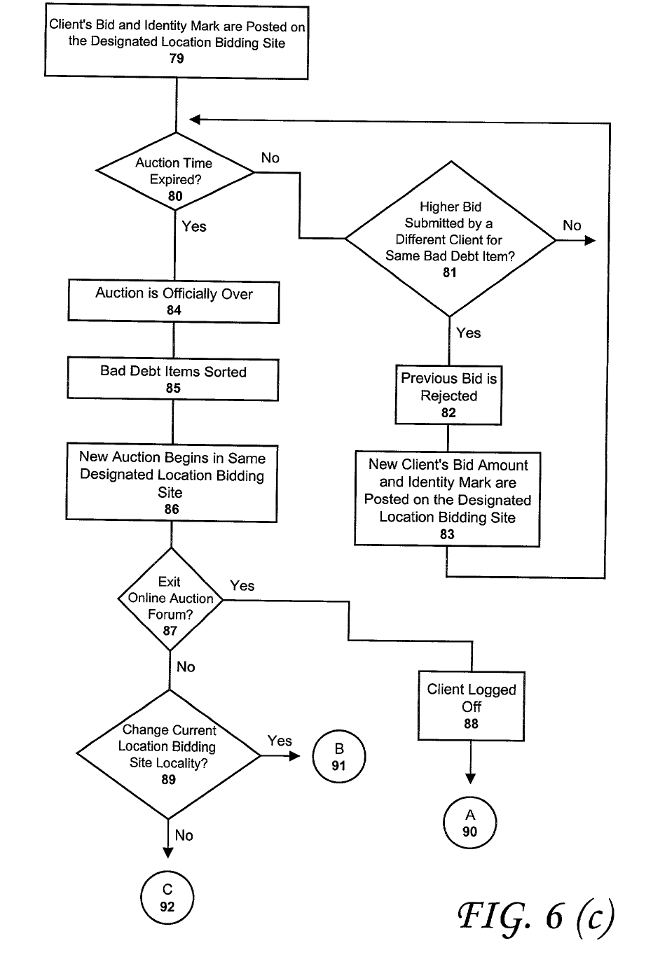

FIG. 6 illustrates, in block diagram form, the real time operation of a preferred embodiment of the method 100 of the present invention. As shown, a client starts at block 55 after accessing the remote host system 14 from a remote location. As previously mentioned access to the online auction forum is preferably predicated upon entering a host web page application 13. Thus, in FIG. 6, a host web page is displayed at block 56. The client then decides whether to enter the online auction forum. If yes, the online auction software 15 initializes, block 57, whereby the client is asked if they are new to the site, block 58. If no, the client is taken to the client log-in page, at block 63. If the client is new, however, they are taken to a registration page, block 59, where they may register with the online auction forum. Although the client may register at any time during an online session, it is preferable that they register prior to entering into a designated location bidding site. Registering with the online auction forum is necessary as it allows a client to open a personal account, establish a user profile, and provide the information needed for processing bad debt items purchased by them.

At block 60, it is determined whether the registration is successful. If no, the client is taken back to the registration page, block 59, otherwise, the client information is received and recorded by the host service provider, block 61. At this point, the client is assigned a unique bidder number/identity mark, block 62 and taken to the client log-in page, at block 63.

After a successful log-in, as determined at block 64, the location bidding site selection menu is displayed, block 65. Upon selecting a specific locality from the menu, block 66, the client is taken to the designated location bidding site associated with that locality, block 67. Here, the client may view the listed bad debt items currently running on the auction, block 67, or decide to bid for any one of them, block 68. In the event that the client decides to change the selected location bidding site locality, block 69, they will be exited out of that designated location bidding site and brought back to the location bidding site selection menu, block 91.

If deciding to bid, however, the client will enter the item number corresponding to the bad debt item, block 70, the desired bid amount, block 71, and their personal password, block 72. Prior to submitting the bid, the client may go back to the designated location bidding site and view other bad debt items or modify their bid, block 92. Upon a decision to submit their bid, block 72, online auction software 15 verifies if the auction time for the particular bidding phase interval has expired, block 74, and if the bid data entered (bid particulars and client identification) is valid, block 76. If the auction time is expired, the bid is rejected, block 75, and the client remains on their selected designated bidding site, block 92, which will most probably display a new bidding phase interval containing a fresh assortment of bad debt items. In the alternative, if the auction time has not expired, but the bid data was entered incorrectly, the bid, likewise, is rejected, block 75, and the client again, remains on their selected designated location bidding site, block 92. Until the auction time has expired, the client may go through this process over and over in order to submit their bid for the same or a different bad debt item.

If the auction time is not expired and the bid data was entered correctly, the online auction software 15 will verify whether the bid amount meets the predetermined minimum bid request amount for the bad debt item bid on, block 77. If not, the bid is rejected, block 75, and the client remains on their selected designated location bidding site, block 92. At this point, they may re-submit their bid if time is left in the bidding phase interval. If the predetermined minimum bid request amount is met, however, software 15 then determine whether the bid amount is the highest bid amount received for the particular bad debt item, block 78. Again, if not, the bid is rejected, block 75 and the client remains on their selected designated location bidding site, block 92. If yes, the client's bid amount and identity mark are posted on the designated location bidding site, block 79 which is viewable to all clients currently in the same designated location bidding site.

At block 80, the software 15 next determines if the auction time for the bidding phase interval has expired. If no, the particular bidding phase interval continues, allowing for a higher bid on the same bad debt item to be submitted by a different client, block 81. If a higher bid is submitted, block 81, the previous client's (now lower) bid is rejected, block 82, and the new client's bid amount and identity mark are posted on the designated location bidding site, block 83. Here, the prior client, who's bid was rejected, may submit a higher bid for the same bad debt item or simply inquire into other available bad debt items displayed on the auction.

When the auction time expires, block 80, the auction is officially over, block 84. At this point, all the bad debt items displayed in the bidding phase interval will be sorted, block 85. Bad debt items that were able to generate a bid at or above the predetermined minimum bid request amount will be deemed sold and re-classified into the purchased items database 19, for processing. Bad debt items that failed to generate the predetermined minimum bid request amount are classified back into their respective designated location bidding site database so that they may be re-displayed on the location bidding site at a later time. With this accomplished, a new auction will begin on the same designated location bidding site, with a new bidding phase interval containing a fresh assortment of bad debt items, block 86. If the client wishes to exit the online auction forum, block 87, they will be logged off the host service provider, block 88, and have to go through the log-in process the next time they wish to enter the site, block 90. If the client decides to remain on the online auction forum, but change the locality of the selected designated location bidding site, block 89, they will be taken to the location bidding site selection menu, block 91. If neither is the case, the client will simply remain on the previously selected designated location bidding site and view the new assortment of bad debt items being auctioned off, block 92.

Although the above discussion focuses on an auctioning process, it is further contemplated that bad debts may be sold via an outright sale to buyers that are logged onto an online forum. Like an auction, an online forum engaged in outright sales of bad debts would utilize the same mentioned assorting arrangement based on the geographic location where jurisdiction is present over the debtor.

The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

I claim:

1. A method of conducting an online auction for the purpose of selling bad debts via a communications network, said method comprising the steps of:
placing select information relating to at least one bad debt on an online auction forum, said select information comprising at least one independent and distinct bad debt item to be displayed on a designated location bidding site of said online auction forum;
establishing at least one designated location bidding site on said online auction forum, said designated location bidding site relating to a specific geographic location and having a database containing of said at least one bad debt item;
classifying said bad debt item on the basis of the geographic location of the territory that has jurisdiction over the debtor, wherein said bad debt item is classified in said designated location bidding site database relating to said same geographic location;
requiring a client to select a particular location bidding site prior to said client being able to bid on said bad debt item.

2. The method as in claim 1,
wherein said geographic location of the territory that has jurisdiction over the debtor is the territory where the debtor is currently domiciled.

3. The method as in claim 1,
wherein said bad debt item is a lot package that includes a pre-grouped assortment of select information relating to at least two of said bad debts each of which pertain to a debtor that is under the same jurisdiction of a common geographic location, said lot package to be displayed as an independent and distinct bad debt item on said designated location bidding site of said online auction forum.

4. The method as in claim 1,
wherein said bad debt item is an apportioned bad debt containing select information relating to a particular bad debt, said apportioned bad debt comprising a fractional portion of the monetary value of the whole of said bad debt and is to be displayed as an independent and distinct bad debt item on said designated location bidding site of said online auction forum.

5. The method as in claim 1,
wherein said select information relating to said bad debt item includes the uncollected monetary value of said bad debt.

6. The method as in claim 1,
wherein said select information relating to said bad debt item includes the geographic location of all the known territories that have jurisdiction over the debtor.

7. The method as in claim 1,
wherein said select information relating to said bad debt item includes the geographic location where the debtor is currently domiciled.

8. The method as in claim 1,
wherein said select information relating to said bad debt item includes rating information that is related to the potential for collection of said bad debt item from its debtor.

9. The method as in claim 1,
wherein said select information relating to said bad debt item includes a predetermined minimum bid request amount, said online auction forum not to accept a bid for said bad debt item that is below said predetermined minimum bid request amount set for said same bad debt item.

10. The method as in claim 3,
wherein said select information relating to said bad debts in said lot package includes the uncollected monetary value of each of said bad debts.

11. The method as in claim 3,
wherein said select information relating to said bad debts in said lot package includes the geographic location of all the known territories that have jurisdiction over the debtor of each of said bad debts.

12. The method as in claim 3,
wherein said select information relating to said bad debts in said lot package includes the geographic location where the debtor of each of said bad debts is currently domiciled.

13. The method as in claim 3,
wherein said select information relating to said bad debts in said lot package includes rating information that is related to the potential for collection of each of said bad debts from their respective debtor.

14. The method as in claim 3,
wherein said select information relating to said bad debts in said lot package includes rating information that is related to the potential for collection of all of said bad debts included in said lot package.

15. The method as in claim 14,
wherein said rating information is based on an average of the total sum of a selected rating figure of each of said bad debts included in said lot package.

16. The method as in claim 3,
wherein said select information relating to said lot package includes a predetermined minimum bid request amount, said online auction forum not to accept a bid for said lot package that is below said predetermined minimum bid request amount set for said same lot package.

17. The method as in claim 4,
wherein said select information relating to said apportioned bad debt includes the uncollected monetary value of the apportioned fraction of said bad debt.

18. The method as in claim 4,
wherein said select information relating to said apportioned bad debt includes the uncollected monetary value of the whole of said bad debt from which said apportioned bad debt was taken.

19. The method as in claim 4,
wherein said select information relating to said apportioned bad debt includes the geographic location of all the known territories that have jurisdiction over the debtor.

20. The method as in claim 4,
wherein said select information relating to said apportioned bad debt includes the geographic location where the debtor is currently domiciled.

21. The method as in claim 4,
wherein said select information relating to said apportioned bad debt includes the fractional share that was apportioned from the whole of said bad debt.

22. The method as in claim 4,
wherein said select information relating to said apportioned bad debt includes rating information that is related to the potential for collection of said apportioned bad debt from its debtor.

23. The method as in claim 4,
wherein said select information relating to said apportioned bad debt includes a predetermined minimum bid request amount, said online auction forum not to accept a bid for said apportioned bad debt that is below said predetermined minimum bid request amount set for said same apportioned bad debt.

24. The method as in claim 1,
wherein said online auction is conducted utilizing consecutive and concurrent bidding phase intervals, each bidding phase interval displaying said at least one bad debt item to be auctioned off and enduring for a predetermined time frame period.

25. The method as in claim 1,
wherein any said bad debt item that generates a bidding price equal to or above its predetermined minimum bid request amount at the end of said bidding phase interval is deemed sold and re-classified into a purchased items database of said online auction forum.

26. The method as in claim 1,
wherein any said bad debt item that fails to generate a bidding price equal to or above its predetermined minimum bid request amount at the end of said bidding phase interval is deemed not sold and reverts back to said designated location bidding site database from which it emerged.

27. The method as in claim 26,
wherein the process for reverting said unsold bad debt item back to said designated location bidding site database is automatic.

28. The method as in claim 1,
wherein said bad debt item is selected from said designated location bidding site database for display on said designated location bidding site on the basis of its numerical positioning in relation to other said bad debt items contained in said same designated location bidding site database.

29. The method as in claim 1,
wherein said bad debt item is selected from said designated location bidding site database for display on said designated location bidding site on the basis of a random selection process, said random selection process occurring without regard to the numerical positioning of any said bad debt item contained in said same designated location bidding site database.

30. The method as in claim 1,
wherein said bad debt item is selected from said designated location bidding site database for display on said designated location bidding site on the basis of an order preference of the controlling personnel of said online auction forum.

31. A system for conducting an online auction for the purpose of selling bad debts via a communications network, said system comprising:
in a remote host system connected to a communications network,
computer processor element for processing data;
data storage element for storing data;
online auction software having a location bidding site selection menu allowing a client to enter a specific designated location bidding site, at least one designated location bidding site module that is related to a specific geographic location, a designated location bidding site database that is associated with said designated location bidding site module and which contains at least one bad debt item, and a purchased items database for storing sold bad debt items, said online auction software configured to run multiple, concurrent, and distinct auction sessions on said remote host system; and having
remote interface element for providing public access to said online auction software,
wherein a plurality of clients may each participate in an auction session of said online auction software, running on said remote host system, from client systems connected to said communications network, and wherein each of said plurality of clients may select a specific designated location bidding site and be able to bid on at least one of said bad debt items displayed for auction on said designated location bidding site, said bid accepted by said online auction software if it is equal to or above said predetermined minimum bid request amount for said bad debt item.

32. A method of conducting an online sales forum for the purpose of outright selling bad debts via a communications network, said method comprising the steps of:
placing select information relating to at least one bad debt on an online sales forum, said select information comprising at least one independent and distinct bad debt item to be displayed on a designated location sales site of said online sales forum;
establishing at least one designated location sales site on said online sales forum, said designated location sales site relating to a specific geographic location and having a database containing of said at least one bad debt item;
classifying said bad debt item on the basis of the geographic location of the territory that has jurisdiction over the debtor, wherein said bad debt item is classified in said designated location sales site database relating to said same geographic location;
requiring a client to select a particular location sales site prior to said client being able to purchase said bad debt item.
